(19) United States
(12) Patent Application Publication
(10) Pub. No.: US 2014/0129961 A1
(43) Pub. Date: May 8, 2014

(54) TOOL FOR MANAGING USER TASK INFORMATION

(71) Applicants: Sergey Mikhailovich Zubarev, Moscow (RU); Yaroslav Vasil'evich Belyaev, Moscow (RU)

(72) Inventors: Sergey Mikhailovich Zubarev, Moscow (RU); Yaroslav Vasil'evich Belyaev, Moscow (RU)

(21) Appl. No.: 13/670,714

(22) Filed: Nov. 7, 2012

(51) Int. Cl. G06F 3/0484

(52) U.S. Cl. CPC G06F 3/0484
USPC 715/752

(57) ABSTRACT

The invention includes methods to aid a user in managing massive data flow and multiple tasks in an optimal and productive way. The invention comprises methods for collecting, managing information for tasks, such as notes, email messages, and files in order to provide for fast access to the information and reduce time spent on organizing data. The invention also comprises methods of measurement priorities and methods of visual representation of multiple tasks that may simplify the choices for a user and make decisions more accurately and quicker, build action plans that are simpler and faster vs the existing ways of working. Moreover, the invention includes methods for tracking changes, receiving new information, and archiving obsolete data. Overall, the methods of the invention can optimize a user's workload and help to improve productivity by gaining the biggest value with fewer resources expended.

Provisional application No. 61/557,219 Filing date Nov. 8, 2011

### BACKGROUND OF INVENTION

In current business activity, in order to manage and solve multiple tasks or projects, a massive information flow is required for it to all be managed. This may include such data as records, tasks, email messages, documents, and files. Currently, there is a number of different applications used to store, retrieve, and manage this information, including different text processing tools, email clients, ordinary file systems, or network. This creates an issue regarding spending time for organizing the data, and search and access with the use of different tools that reduce your efficiency.

Another issue here is that time and resources with an abundance of information may not be used in an optimal and productive way. With multiple tasks or projects to complete and excessive information received every hour, a person can make suboptimal decisions and spend his or her time on a task that creates less value than another, more critical and important one. Making a right, more optimal choice between multiple tasks in a fast changing environment in order to focus on the most valuable task and gain the biggest outcome becomes a separate task and a challenge.

At last, managing hundreds and thousands of email messages received is a complex task in itself. A person needs to read, understand, and respond to new information received in order to achieve business or personal objectives. The issue that is raised here regards how to manage email messages in a productive, and most efficient, way. The invention addresses all of the issues above in order to achieve personal productivity and to organize time and resources in the most optimal way.

### BRIEF SUMMARY OF THE INVENTION

The invention addresses the issues raised above, as a personal tool for managing user task information. The tool allows entering, storing, searching, and retrieving of information required for a user to manage his or her tasks in one application. The tool can help in managing user information, such as tasks, subtasks, related email messages and files in more productive and optimal ways by providing methods of organizing a user's work with a focus on the most important aspects. The tool uses a combination of measurement tools, original visual representation and linking of all information related to a user's tasks.

The tool supports entering information about tasks, subtasks, collecting email messages and files by linking them with the task in order to gather all the information required for a task in one single place. This may organize data in a more simple way for the user and reduce the time required for access. Automatic classification of emails by task is provided by a tool that can reduce the time a user needs for sorting emails by his or her tasks.

The tools provide a method for measuring the priority of a task by using five key parameters, which are importance, urgency, difficulty, risk of delay, and completion of the task. All the measures may be completed by the use of scales that are visually represented to the user by distinct colors, which may simplify users' choice. The measuring priority can help a user make a choice for a more valuable task in a more accurate way. A task with a higher priority is thus considered to be more valuable for a user and that helps to define the sequence of actions in a more optimal way.

The tool provides method for measuring weight of a task by using four parameters, such as risk of delay, percent of task completion, difficulty of the task, and number of unread email messages. Task with more weight is thus considered as more valuable for a user which helps to define sequence of actions in more optimal way.

The tool uses priority and weight measures in order to build a sequence of tasks from the higher value to lower value, which can simplify the creation of the action plan and makes it faster. The tool represents all the tasks in sequence in the columns by colored shapes, such as boxes or bubbles with different sizes depending on the weight of a task, which helps the user visualize the sequence of actions. Such representation may help to see all the tasks on one display, compare tasks to each other and make a decision as to which task is to be worked on in a given time frame. It is suggested to the user that they should work on tasks in such a sequence from the most valuable to the least valuable in order to achieve the best possible outcome given the importance of tasks. Users can decide to not work on the least valuable tasks, thus reducing the scope of this work and can use his or her time more optimally.

With the receipt of new information, such as a new email message, the tool after automatic classification of the email and linking it to a task, automatically triggers the recalculation of the weight of a task. The task then bubbles up in a column, thus it can advise a user that a new sequence of actions exists depending on the weight of a task.

The tool uses a feature of adding semantic tags to email messages sent by the user so that if another person uses the same tool it will read the semantic tag and classify the email in order to link with a task more accurately. The tool may suggest that the recipient should create a new task based on the email received, which may help both users to exchange information and collaborate in a more efficient way.

The tool uses a method of measurement of priority of email messages by importance and urgency, i.e. it can help a user to make a decision on what he or she needs to read and respond to first.

The tool combines email messages in groups and represents email messages and groups by water drop shapes, which allows making a depiction of numerous emails in a more compact way, thus locating more information concentrated on one display for fast reviewing by the user. The size of the water drop of the email messages group will be bigger depending on the number of email messages in the group, which may allow a user to see where more information is collected. The priority of emails may be represented by colors. Thus, a combination of a more compact representation of numerous emails on one display, size and color of email messages group depends on the number of emails and its priority may help the user to identify where he or she needs to pay the most attention to first, i.e. they can build a sequence of his or her actions in a more optimal way.

The tool contains a method of tackling emails by response set by the user in order to help identify if the expected response is received, i.e. it can advise the user to pay attention to the received information.

The tool contains a method for checking the usage of the information and archiving of data such as tasks, subtasks, email messages, or files by hiding. This may reduce information that is visible to the user, i.e. scope of work, thus the user can use their time in a more optimal way.

### BRIEF DESCRIPTION OF THE DRAWINGS

FIG. 1 is a front view of a main screen of a tool for managing user task information with search and task selection representing Option A;

FIG. 2 is a front view of the main screen shown in FIG. 1 of a tool for managing user task information in an alternative depiction with search and task selection representing Option B;

FIG. 3 is a front view of a screen for editing a task;

FIG. 4 is a front view of a screen with tasks displayed in columns and showing a task information preview form;

FIG. 5 is a front view of a screen that shows new information arriving to a task in representation of Option A;

FIG. 6 is a front view of a screen that shows new information arriving to a task depicted as bubble in representation of Option B;

FIG. 7 is a front view of a main screen with a email preview form;

FIG. 8 is a front view of a flowchart for hiding unused information;

FIG. 9 is a front view of a flowchart for archiving information;

FIG. 10 is a front view of a flowchart for receiving and classifying information;

FIG. 11 is a front view of a screen showing a list of email groups;

FIG. 12 is a front view of a screen showing tracking of an email; and

FIG. 13 is a front view of a screen showing adding files to a task.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Broadly, an embodiment of the present invention generally provides a tool for managing user task information.

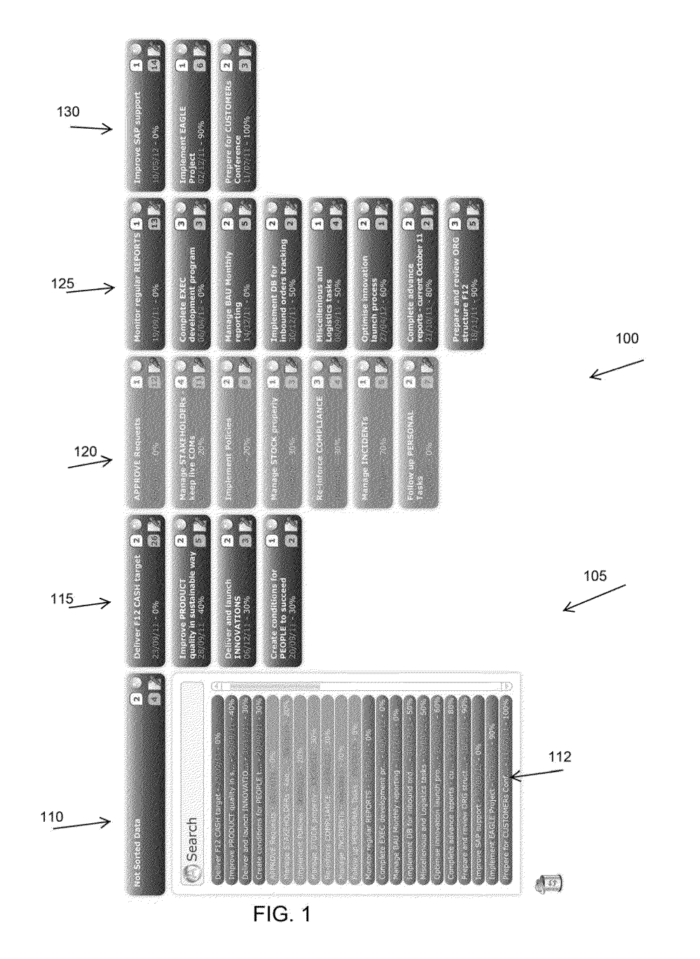

Referring to FIG. 1, a tool for managing user task information 100 (hereinafter “tool”) may include a main screen 105 that includes a box named “Not sorted data” 110 where unsorted emails are stored and a search drop-down list 112 with selectable tasks may be listed according to priority. The selectable tasks may be displayed in boxes by columns according to color. FIG. 1 shows a red column 115, an orange column 120, a green column 125, and a blue column 130, displaying tasks from the search list 112. A glass bead may be a button on each box of the task to activate a dialog with an email list. An icon with pen and paper may activate a dialog with a list of files. In an exemplary embodiment, the tool 100 may include working with tasks and subtasks, working with emails and organizing files. This representation of tasks and information will be referred to as Option A.

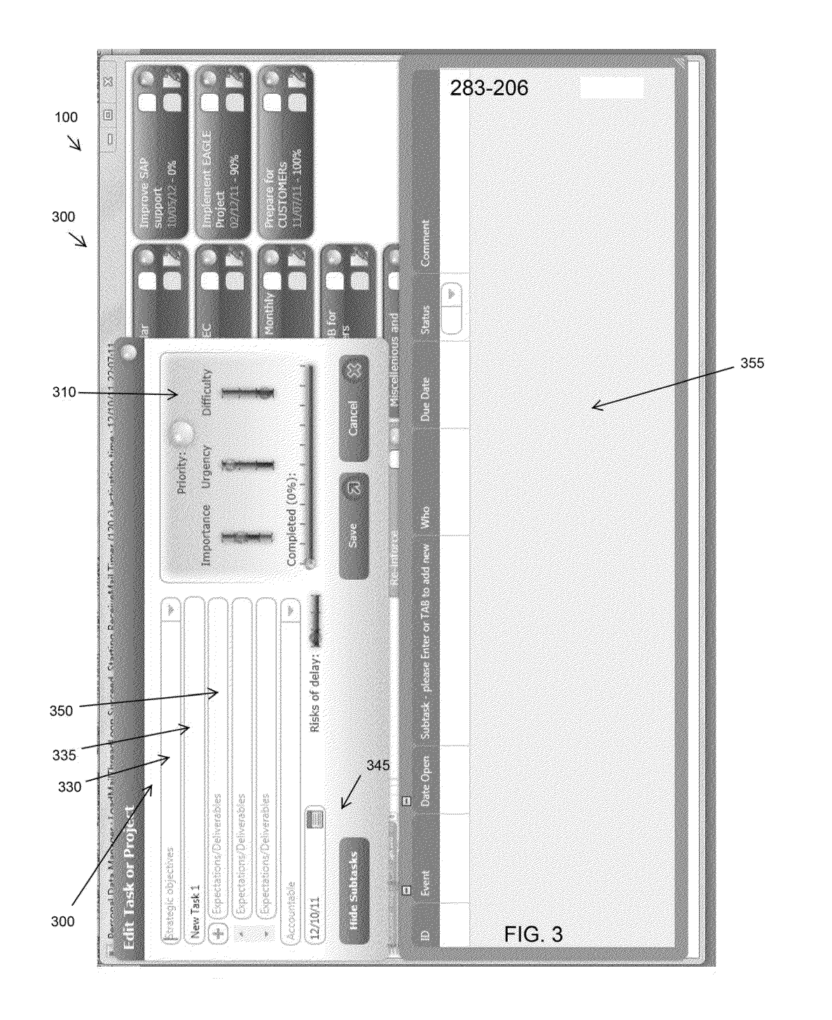

In an exemplary embodiment, the tool 100 may include working with tasks and subtasks, working with emails and organizing files. Information on a task may be used to help a user to manage activity. A user may input information on tasks into the tool 100. The tool 100 may help the user to measure priority of tasks and visualize tasks. By double clicking on a working area of the tool 100 a task may be created and formed and shown on the computer screen. When a task form appears animation is used. A task form may contain the following fields: strategic objectives (combobox allowing the addition of new items and deletion of items), and task (text field), and expectations (text field). By default, three expectations may be visible with a possibility of adding up to ten additional expectations), accountable (combobox with possibility to add new items and delete them), and due date (date). The task form may also contain visual scales. Working with fields of form may be standard functionality, yet opening of comboboxes may be animated with appearance of a list of values. All information from task fields may then be used for email classification. Creation of a task will be demonstrated on FIG. 3.

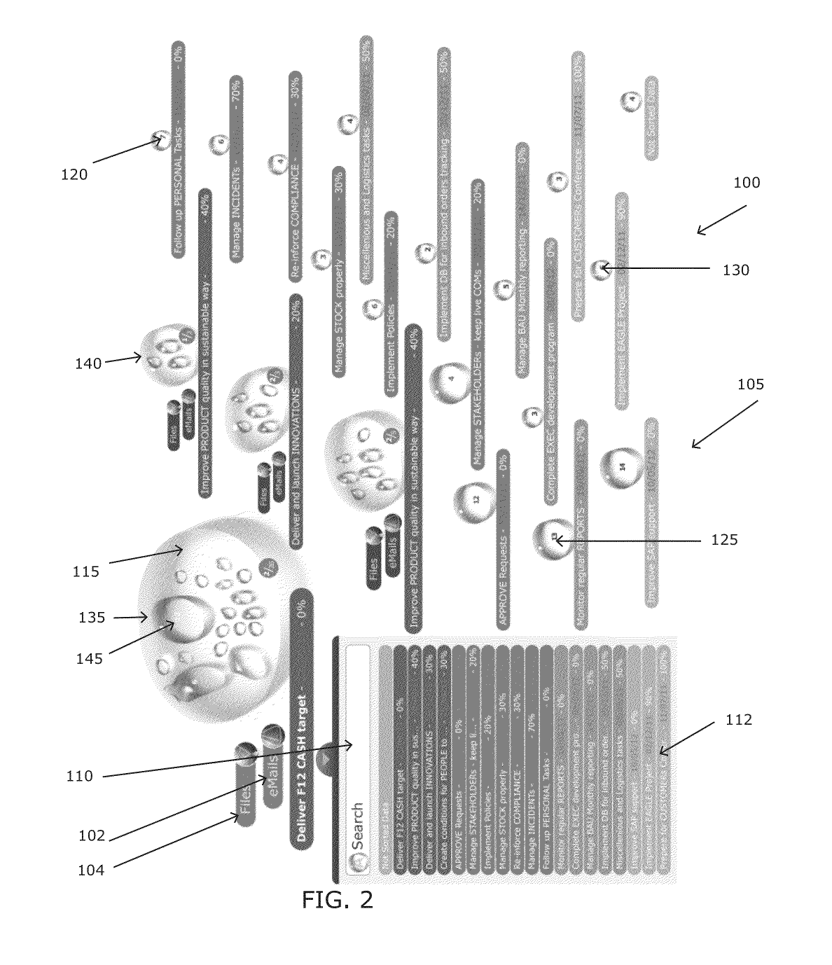

Referring to FIG. 2, a tool 100 for managing user task information may include a main screen 105 displayed in a different manner than in FIG. 1. The main screen 105 may include a search drop-down list 110 with selectable tasks 112 with priorities and sorted by weight. The selectable tasks 112 may be displayed as bubbles sorted by priorities and weight, where color of bubble represents priority of task and size of bubble representing weight. FIG. 2 shows a red group of bubbles 115, an orange group of bubbles 120, a green group of bubbles 125, and a blue group of bubbles 130, displaying tasks from the search list 110.

Bubbles 135, 140 may include emails represented as water drops inside the bubbles 135, 140. In an exemplary embodiment, the tool 100 may represent emails as water drop shapes or as a single colored shape. Emails may be grouped with the same subject and an email group 145 may be displayed by a water drop with numeric indicator representing number of emails in the email group 145.

The bubble representing task, for example, the red bubble 115 may include selectable files. A button 104 may activate a dialog with a list of files and a button 102 that may activate a list of email messages. Thereafter this representation of tasks and information will be referred to as Option B.

In an exemplary embodiment, all information on tasks, subtasks may be stored in an external file which may then be used to restore saved information when user opens the tool 100 the next time. Once the user clicks a save button, a task may then be visually indicated on the screen in a working area of the tool 100. The tasks, its priorities and weights may be represented by two options depend on setting of style by user. Option A—a task may be represented by a colored box of equal sizes, the color may represent priority of a task as displayed on FIG. 1. Weight of task may be indicated by order in which task boxes are sorted, such that a task with a biggest weight may be in a top position and a least weighted task in the lowest position. Boxes may be located in order by columns—with red column on a left side, an amber column to the right of the red one, then green and finally blue at a right most position. Therefore tasks with specific priorities may be grouped by column and sorted by weight. Option B—Task may be represented by bubbles with different color representing priority of task and different size representing weight of task as displayed on FIG. 2. A most weighted task may be indicated by larger size and smallest weights by a smallest size. Bubbles may be located in rows to group priorities, where most of the rows on the screen are red colored shapes, then next below may be orange, then green, then blue. Tasks may be sorted by weight where the most weighted task may be located on the left side of a row and a least weighted task to the right.

This representation of tasks and its priorities as displayed on FIG. 1 and FIG. 2 may help a user clearly differentiate importance of the tasks.

Referring to FIG. 3, a tool for managing user task information 100 may include a screen 300 for editing a task or project. A strategy objective that a user will work on may be entered or selected in a select drop down list 330. A new task description may be entered in a text box 335. Expectations and deliverables 350 may be entered and listed under the selected or created task. A due date may be selected for the task in a select box 345. Subtasks may be displayed in a subtask display box 355. The subtask display box 355 may be hidden by pressing a button 315 for hiding the subtask display box 355. A priority selection box 310 may be displayed for setting priority for the task. The user can measure importance, urgency, difficulty and risk of delay of the task by using colored scales. Once the user sets scales then priority is automatically calculated and bead changes its color (Orange bead).

In an exemplary embodiment, a user may set priority and weight of tasks by measuring specific parameters. The position of tasks, and priorities and weights may be visually indicated which may help a user to make differentiation of tasks. A user may measure priority of a task, and weight of a task and by use of specific scales.

In an exemplary embodiment, the task form may have five scales and one visual priority indicator 310. Scales may include: Importance, Urgency, Difficulty, Risk of delay, and Completed (%). The Importance scale may be represented by a vertical slider with four different colors for each step—blue, green, amber, and red, with blue located at the lowest position and red color at the highest position. Each color may represent a magnitude of importance. Each level of a slider is represented by a colored water drop, which may change color when it is moved by a user to specific step and visually very distinctive from step to step. Urgency and Difficulty scales may use the same principal as Importance but may have three colors—green, amber, red, each representing magnitude. Risk of delay may use the same principal and colors as Urgency and Difficulty scales, and may be located horizontally.

In an exemplary embodiment, priority may be calculated based on Rate of Importance (ROI) and ranges which are described below. When user moves a slider, ROI of a task may be calculated by the formula=I*w1+U*w2+(3−D)*w3+R*w4, where I—importance value (1-4), w1—weight of importance=10, U—urgency value (1-3), w2—weight of urgency=5, D—difficulty value (1-3), w3—weight of difficulty=1, R—risk of delay (1-3), w4=weight of risk=5. Weights are set by the user and may be changed if required.

In an exemplary embodiment, priority may be identified equal from 1 to 4 as follows: Priority=1 (Low), when ROI<39; Priority=2 (Medium), when 40<=ROI<=47; Priority=3 (High), when 48<=ROI<=59; Priority=4 (Critical), when ROI>=60. Ranges may be set by the user and may be changed.

Priority may be indicated by water drop color located on the task form with specific color—blue (low priority), green (medium), orange (high), red (critical). After calculation of priority an indicator may immediately change color—thus priority may be clearly visible for a user based on his measurement set by each scale.

Weight of task may be calculated by the following formula: W=R*w1+(1−C)*w2+(1−D)*w3+NC*w4, where R—risk of delay value (1-3), w1—weight of risk=5; C—% of task completion (0-100% value in 0-1, where 50%=0.5), w2—weight of task completion=5; D—difficulty of task (1-3), w3—weight of difficulty=5; NC—number of email messages linked with task in unread state and with high priority, w4—weight of emails=1. Weights may be set by the user and may be changed as required.

In an exemplary embodiment, a completion scale may contains 11 steps—from 0% to 100% with step of 10%. A slider may change color when the user moves the slider.

In an exemplary embodiment, when a user is finished entering all required information in task fields and measured priority and weight by scales, the user may save a task by clicking the “Save” button on the task form. The user may choose “Cancel” button, in this case task will not be saved. Saving of task information may be done with an external file recorded on the disk.

In an exemplary embodiment, in order to split a task into subtasks a user can double click on a shape of a task visually represented. A task form 300 may appear on the screen. On the task form there may be the button “Add Subtask”. Upon clicking this button a SubTask form may be opened below the Task form as displayed in 355.

In an exemplary embodiment, SubTasks may be entered in table type form with the following fields: ID—automatically generated, Event—text field, source of subtask that user may want to enter as reference, DateOpen—date when subtask entered/initiated, SubTask—text description of subtask, Who—text field for entry of responsible person, Due Date—date to complete, Status—may be indicated by signs—0, 1/3, 2/3, V—in combobox—, and Comment—text field.

In an exemplary embodiment, there may be two buttons “−” to hide Event and Date Open which changes from “−” to “+” if the user hides these fields. The SubTask form may comply with the Task Form. After entry the user can sort subtasks by clicking the head of columns. The user may click “Save” on a Task form to save subtasks or “Cancel” to cancel entry or changes. If the user enters an empty value in a field of the SubTask, the tool 100 may then add text “New SubTask”.

In an exemplary embodiment, If the user needs to re-sort subtasks and move subtasks from one task to another the user may use the Drag and Drop operation. For that the user may first open the Task form and the SubTask form (task source). Then the user may pick up any of subtask or group of subtasks and then by click-and-keep left mouse button may drag a subtask. A specific icon may indicate the start of dragging. The user then can drop the subtask to any of tasks. A subtask may be then moved from task source to task target.

If a task target is not visible on the screen the user may first scroll task shapes: from bottom to top or otherwise in Option A of tasks representation, OR from left to right or otherwise in Option B of tasks representation. Once a task target is visible on the screen user then make moving subtasks by Drag and Drop operation.

In an exemplary embodiment, when a user updates a task the user may double click on task shapes on the screen. The Task form 300 may then appear in an animated way. The user may edit any field in Tasks or SubTasks forms. The user also can evaluate risks of not completion of task by time. The user may use the Risk of delay scale and move the slider to a certain position—from green (no risk), to orange (average risk), or red (high risk). Priority and weights may then recalculated and indicated in priority indictor on Task form.

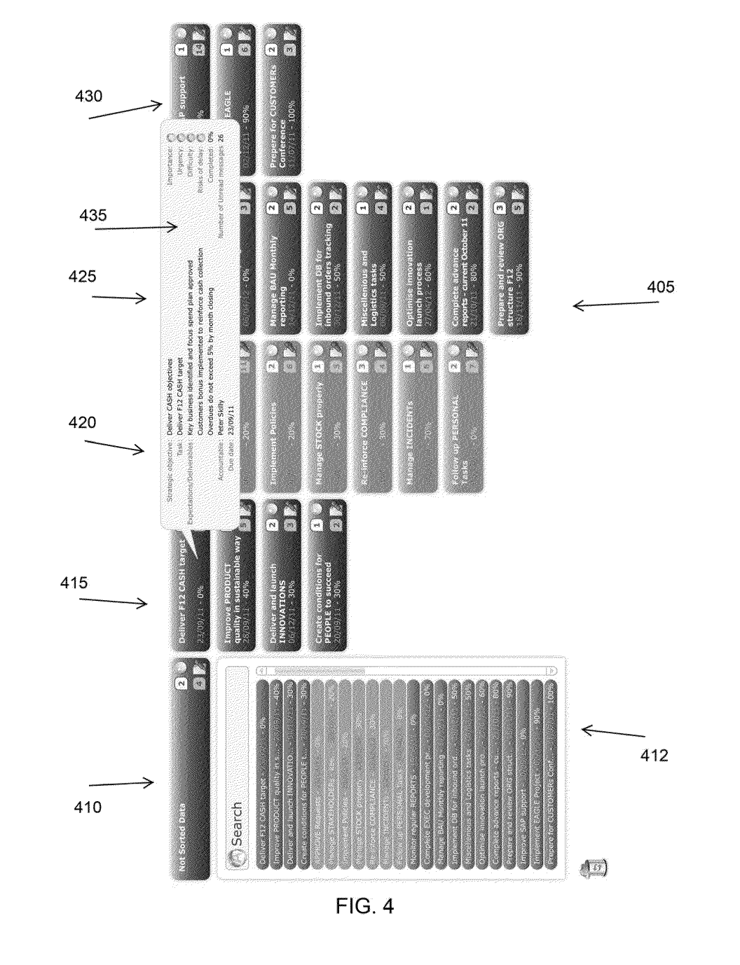

Referring to FIG. 4, a tool for managing user task information 100 may include a preview screen 405 that includes a box for unsorted data 410 with selectable tasks 412. The selectable tasks 412 may be displayed in columns, for example, according to color. FIG. 4 shows a red column 415, an orange column 420, a green column 425, and a blue column 430, displaying tasks from the search list 410.

In an exemplary embodiment, If the user wants to get quick information about task without opening a Task form the user may preview a task. For that the user may move mouse the cursor above task shape. An animated preview 435 may then be visible with information on the task, including “Strategic objective”, “Task”, “Expectations”, “Accountable”, and “Date due”. On the right side of the preview by colored water drops may include “Importance”, “Urgency”, “Difficulty”, “Risk of delay”, and “Completed %”.

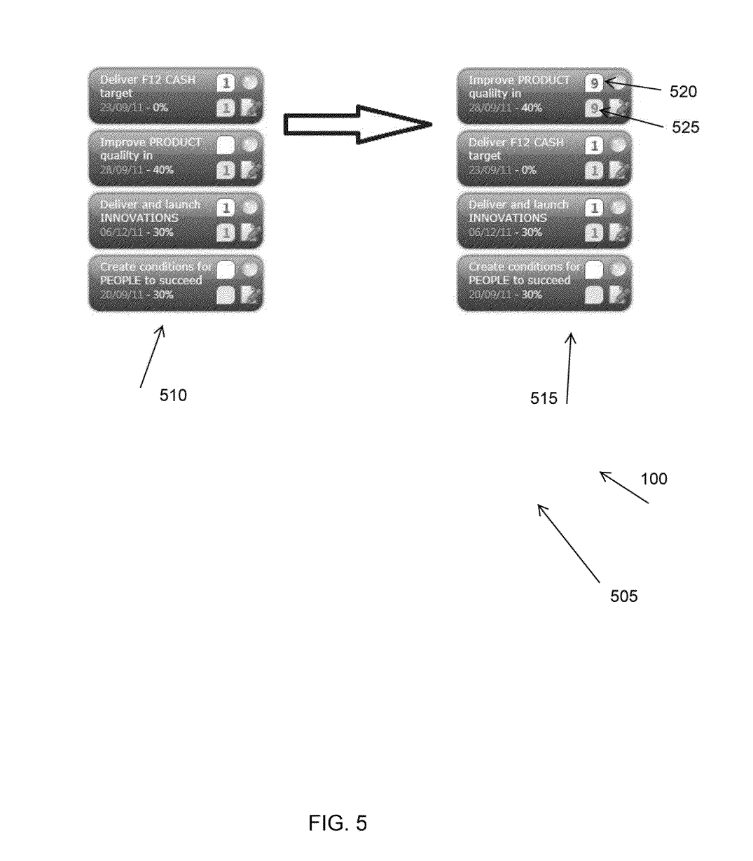

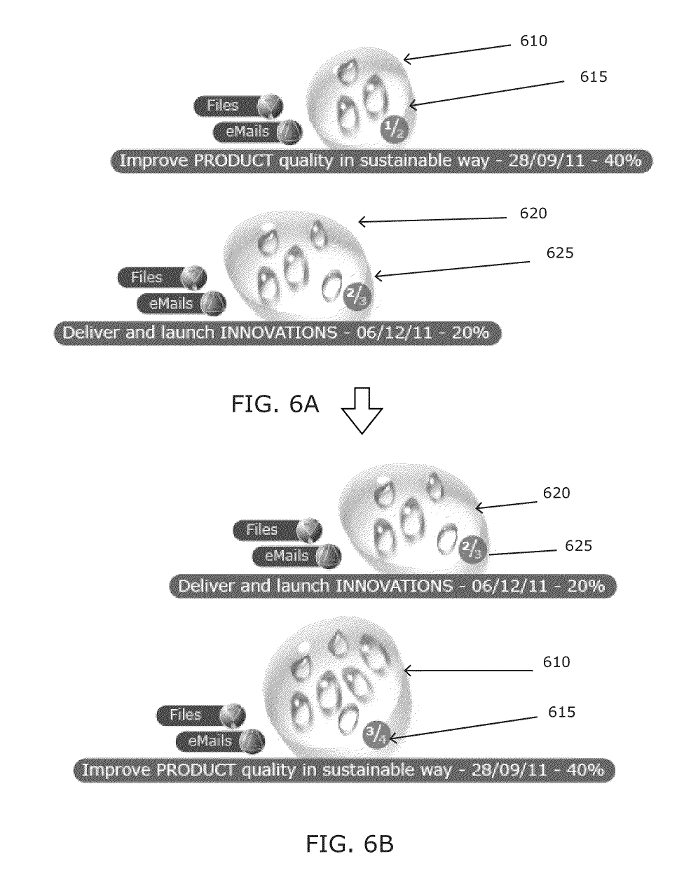

Referring to FIG. 5, the tool for managing user task information 100 may include a screen 505 for showing task boxes 510. After arrival of the information, the information may be stored and sorted in a sorted display 515 with the task receiving the most quantity of unread number of emails on top. In an exemplary embodiment, there may be visual changes of task representation when new information arrives. When new emails are received this event may be visually shown in a task shape. Emails may be sorted by tasks. Once email is located to specific task following changes may be applied: (1) there may be a new mail numeric indicator that may change its value—increases its value once new mails are received since the user last opened a list of emails of the task. The upper number 520 may indicate number of new emails, and the lower number 525 may indicate the number of unread emails. Once a user opens a list of emails of this task and read the new emails, an indicator of new mails may become zero reflecting that the user has seen new mails. (2) Unread emails numeric indicator may change its value to reflect total quantity of new unread emails received and located for task. (3) Weight of task may be recalculated if email is received with high priority, then a task shape may be moved to a new position inside a priority column/row as displayed at 515, Size of a task shape may be changed if a user uses Option B of representation of tasks (See FIG. 6 below). All of these changes indicate receipt of new information so that the user can clearly understand which task has new mails, thus new information.

Referring to FIG. 6, a tool 100 for managing user task information may include an option B for representation of tasks. The tool may include a task 610 with new emails and unread emails. The numbers “1/2” 615 may represent, for example, one new email and 2 unread emails. The tool may include another task 620 with numbers “2/3” 625 that may represent 2 new emails and 3 unread emails.

Referring to FIG. 6, the task 620 is shown as in FIG. 6, with numbers 625 showing 2 new emails and 3 unread emails. The task 610, however, is shown with larger size than in FIG. 6. It may represent 3 new emails and 4 unread emails. After new information such as new email arrives in a task, the task may increase in size as shown with task 610. All of these changes indicate receipt of new information so that the user can clearly understand which task has new mails, thus new information.

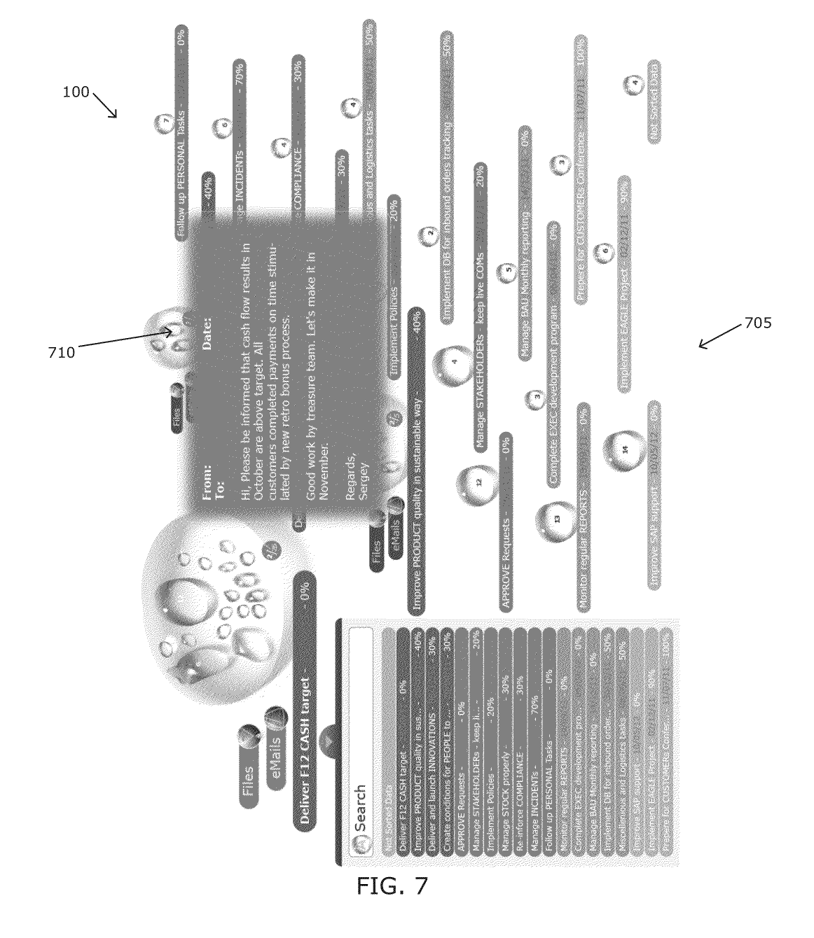

Referring to FIG. 7 a tool 100 for managing user task information may include the main screen 705 from FIG. 2 in which a email message 710 is displayed on top of the main screen 705. The main screen 705 may allow for preview of emails. This can be helpful for the user to quickly review content of emails in particular task.

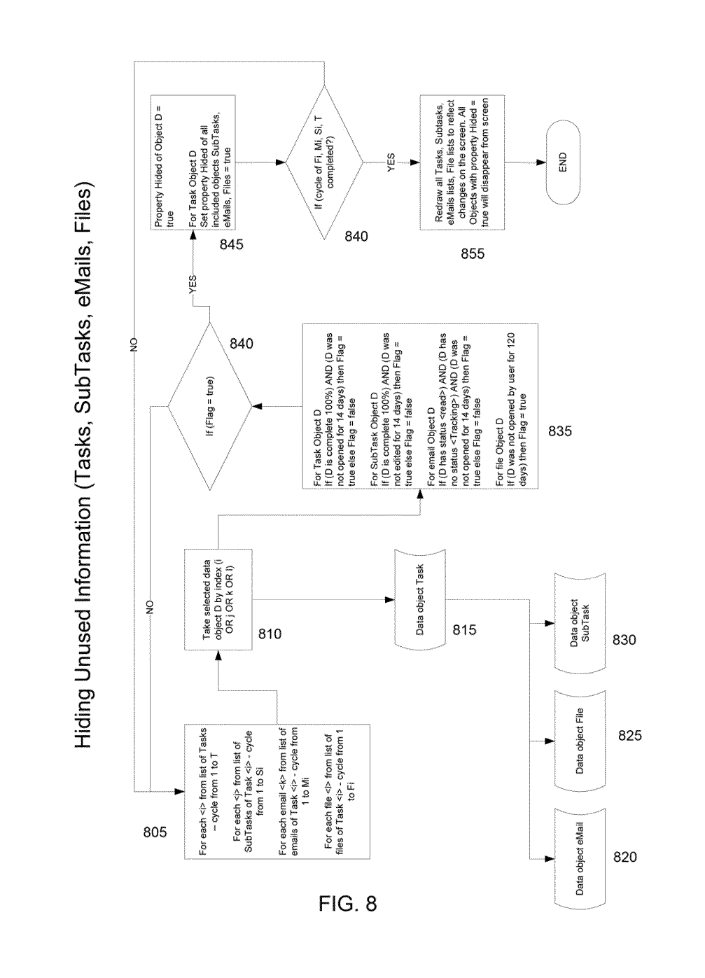

Referring to FIG. 8, the tool 100 may hide unused information, such as tasks, subtasks, emails and files.

In an exemplary embodiment, the user may archive and hide obsolete tasks and subtasks. When a task or subtask is completed then this information may not be needed to be shown on the screen and may free up visual space. Achieving and hiding of tasks and subtasks and related emails and files may help the user to filter out “old” and unused information which may save space on the screen and help the user to focus on more important and active tasks and related information.

In an exemplary embodiment, if tasks or subtasks are completed and not opened by user for fourteen days then they may be hidden from the screen. The user can unhide them by right clicking to open a context menu and choose the function “Unhide unused tasks/Subtasks”.

If tasks/subtasks are completed and not opened by user for thirty days they may receive the status “Archived”. Archived tasks/subtasks may not be shown on the screen, yet all information may still be stored. The user can show archived tasks and subtasks by choosing the function “Show archive” from context menu. Emails and files linked with a task may also get the status “archived”.

Similar to tasks/subtasks archiving and/or hiding there may be a function to move obsolete emails to archive or/and hide it to free up visual space in emails list or task water drop shape if Option B is used. Archived email items may be physically moved from an Inbox of a mail client (e.g. MS Outlook®) to archive a file which frees up physical space in the Inbox. If a group/email is read and not opened by user for 14 days then it is hidden in the email list or in a task water drop shape. The user can unhide them by right clicking in the email list to open context menu and choose function “Unhide unused emails”.

If group/email is read and not opened by user for 30 days then the group/email gets status “Archived” and may be moved to archive. An archive may be a storage file different from where new incoming emails are located (Inbox). This may save physical space in an Inbox mail file. The user can open archived emails by choosing the function “Show archive” from a context menu. A task that is linked with the email is not immediately moved to archive as it has its own cycle for archiving.

The tool 100 may archive obsolete and may hide unused files. Similar to tasks/subtasks archiving and/or hiding there may be a function to set obsolete files as archived and hide obsolete files on the files on the File List. The user can unhide files by right clicking in the File list to open the context menu and choose the function “Unhide unused files”. If file is not opened by user for 365 days then the file may receive “archived” status. Archived files may not be shown in the file list of the Task. The user can show all archived files by choosing the function “Show archive” from the context menu. The task that is linked with the file may not be set to archived status as it may have its own cycle for archiving. As result there may be three groups of files may exist—active file, hidden or archived. The user can turn on visible or hidden and archived files.

Hiding unused information may include the following steps. A step 805 may include

For each <i> from list of Tasks
- cycle from 1 to T
For each <j> from list of
SubTasks of Task <i> - cycle
from 1 to Si
For each email <k> from list of
emails of Task <i> - cycle from
1 to Mi
For each file <l> from list of
files of Task <i> - cycle from 1
to Fi

A step 810 may include:

Take selected data
object D by index (i)
OR j OR k OR l)

A step 815 may include taking a data object task. A step 820 may include taking a data object email. A step 825 may include taking a data object file. A step 830 may include taking a data object sub task.

A step 835 may include:

For Task Object D
If (D is complete 100%) AND (D was
not opened for 14 days) then Flag =
true else Flag = false
For SubTask Object D
If (D is complete 100%) AND (D was
not edited for 14 days) then Flag =
true else Flag = false
For email Object D
If (D has status <read>) AND (D has
no status <Tracking>) AND (D was
not opened for 14 days) then Flag =
true else Flag = false
For file Object D
If (D was not opened by user for 120
days) then Flag = true

If Flag=true, a step 840 may include:

Property Hided of Object D = true
For Task Object D
Set property Hided of all
included objects SubTasks,
eMails, Files = true

A step 850 may decide If (cycle of Fi, Mi, Si, T completed). If so, a step 855 may include redrawing all tasks, subtasks, email lists, and file lists to reflect changes on the screen. All objects with property Hided=true may disappear from the screen.

If (Flag=false) or if (cycle of Fi, Mi, Si, T) is not completed, then processing moves to step 805 as described above.

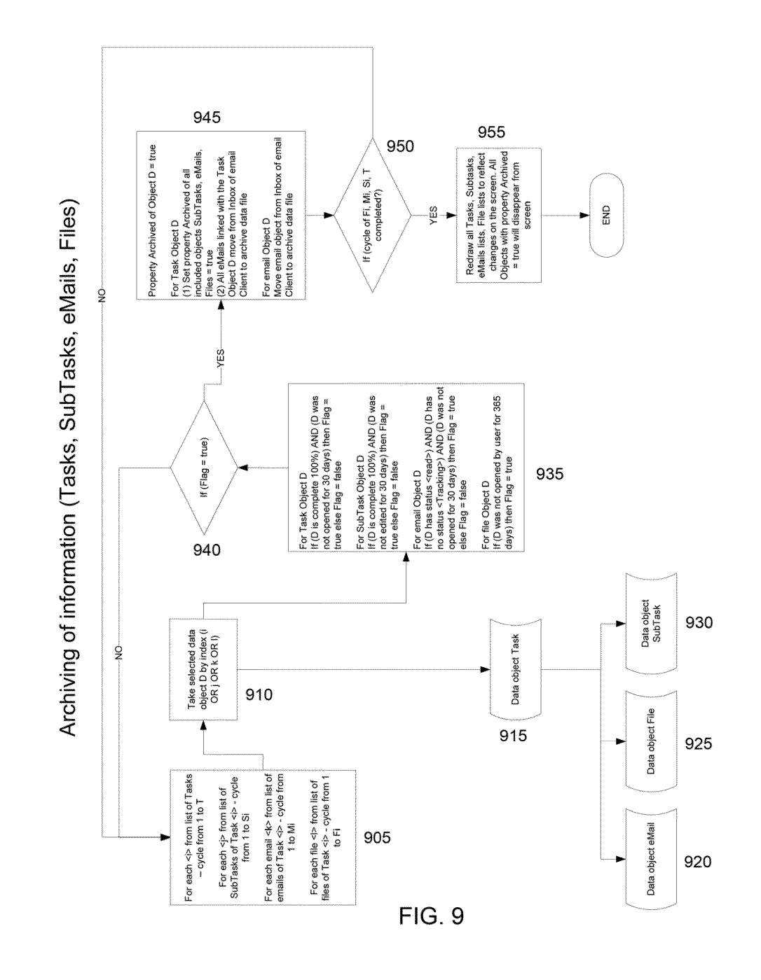

Referring to FIG. 9, the tool 100 may archive information, such as tasks, subtasks, emails and files.

A step 905 may include

For each <i> from list of Tasks
- cycle from 1 to T
For each <j> from list of
SubTasks of Task <i> - cycle
from 1 to Si
For each email <k> from list of
emails of Task <i> - cycle from
1 to Mi
For each file <l> from list of
files of Task <i> - cycle from 1
to Fi

A step 910 may include:

Take selected data
object D by index (i)
OR j OR k OR l)

A step 915 may include taking a data object task. A step 920 may include taking a data object email. A step 925 may include taking a data object file. A step 930 may include taking a data object sub task.

A step 935 may include:

For Task Object D
If (D is complete 100%) AND (D was
not opened for 30 days) then Flag =
true else Flag = false
For SubTask Object D
If (D is complete 100%) AND (D was
not edited for 30 days) then Flag =
true else Flag = false
For email Object D
If (D has status <read>) AND (D has
no status <Tracking>) AND (D was
not opened for 30 days) then Flag =
true else Flag = false
For file Object D
If (D was not opened by user for 365
days) then Flag = true

A step 940 may include deciding if Flag=true. If Flag=true, the a step 945 may include:

Property Hided of Object D = true
For Task Object D
(1) Set property Archived of all
Included objects, Subtasks, emails,
Files = true
(2) All emails linked with the Task
Object D move from inbox of email
Client to archive data vile
For email Object D
Move email object from inbox of email
Client to archive data file

A step 950 may decide If (cycle of Fi, Mi, Si, T completed). If so, a step 955 may include redrawing all tasks, subtasks, email lists, and file lists to reflect changes on the screen. All objects with property Archived=true may disappear from the screen.

If (Flag=false) or if (cycle of Fi, Mi, Si, T) is not completed, then processing moves to step 905 as described above.

In an exemplary embodiment, a user can also analyze information about all of his tasks and emails status by use of reports. For this the user may right click to open context menu, and may choose the Reports function. A Report form may then be opened in which the user can choose standard preset reports or click a Construct report button to construct a new report. For construction of a report all fields of Tasks, and SubTasks are available to choose from. The report may then be indicated on a new form—screen in the form of a paper document with indication of chosen information in report.

In an exemplary embodiment, a user may delete and restore Tasks or Subtasks. Confirmation of deletion may be asked and then the Task or Subtask may be moved to a Garbage Bin with animation. If the user deletes the Task then related emails and files may also be deleted and moved to the Garbage Bin together with the task. The user can restore deleted Task and/or Subtasks by: (1) Opening the Garbage Bin, select task/subtask by left click, right click to open context menu, select “Restore”, (2) Drag and drop selected task to working area of application, OR drag and drop subtask to specific task. An alternative to deletion may be archiving and/or hiding functions.

The user may download and group emails. Emails may be considered as information related to user tasks that the user manages. Emails may be linked with a task and sorted out by task automatically by the tool 100. Sorting of emails by tasks may help the user to focus on the most interesting emails for him at given moment of time and makes his work more efficient by concentrating on most important emails to read and respond.

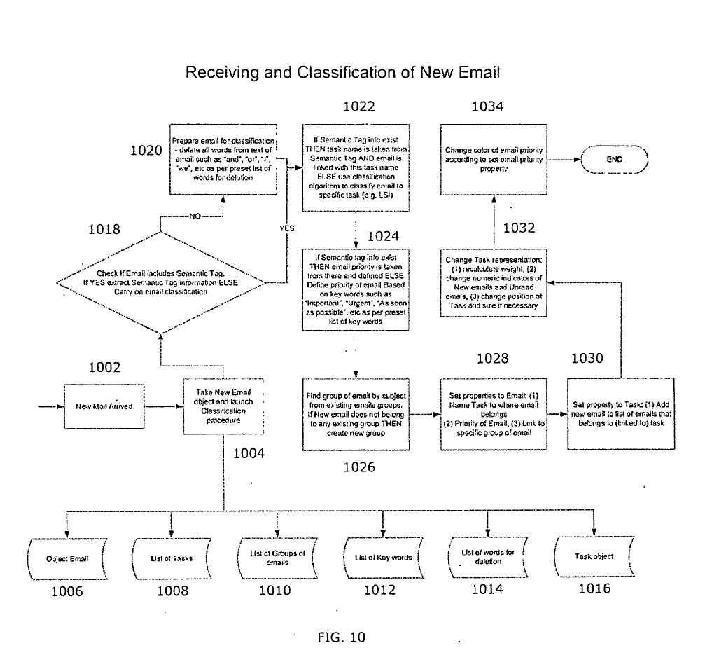

Referring to FIG. 10, A tool 100 for managing user task information for a task object 1016 may include receiving and classifying new email. The tool 100 may include a step of new mail arriving 1002. A step 1004 may include taking a new email object 1006 and launching a classification procedure. A step 1018 may include checking if the new email includes a semantic tag. If so, semantic tag information may be extracted from the semantic tag. Otherwise, email classification may continue. A step 1020 may include preparing an email for classification by deleting all words from the text of an email such as “and”, “or”, “I”, “we”, etc as per preset list of words for deletion 1014. A step 1022 may include checking if semantic tag information exists, then a task name is taken from a semantic tag and the email is linked with this task name. Otherwise a classification algorithm may classify email to a specific task as a list of tasks 1008. A step 1024 may include checking if semantic tag information exists. If so, then email priority may be taken from there and defined. Otherwise, priority of email may be based on keywords such as “important”, and “urgent”, based on a preset list of key words 1012. A step 1026 may include finding a group of emails 1010 by subject from an existing list of groups of emails 1010. If the new email does not belong to any existing group, then a new group may be created. A step 1028 may include setting properties of the new email by (1) naming the task to where the new email belongs, (2) setting priority of the new email, and (3) setting a link to a specific group of emails. A step 1030 may include setting the properties of the task by adding the new email to a list of emails that belong to or are linked to the task. A step 1040 may include changing task representation 1032 by (1) recalculating weight of tasks, (2) changing numeric indicators of new emails and unread emails, and (3) changing the position and size of the task if necessary.

In an exemplary embodiment, the following may describe work flow with emails. Emails may be downloaded from an email server. Once downloaded, emails may be linked to tasks by classification. Automatic classification of emails may be used to allocate emails to a specific task.

Classification may start with checking if an email contains semantic tag as in step 1018. If another user uses the tool 100 then when emails are sent by another user a semantic tag may be added to the email. The semantic tag may contain information on the task which was created by another user and may include all fields of information of tasks. The semantic tag attached to emails may simplify classification.

In an exemplary embodiment, as in step 1022 if there is semantic tag attached to email then classification may be complete. The task may be identified equal to one contained in a semantic tag. The tool 100 may then check if such task is included in a user task list. If such task exists then the email is linked with this task. If the task does not exist in the user task list then a new task may be created with all information contained in the semantic tag and the new email with the tag may be allocated in this task.

In an exemplary embodiment, If the semantic tag is not attached to the email then a classification algorithm may be used as in step 1022. As an example, the Latent Semantic Indexing (in particular matrix V to compare documents) algorithm may be used. Description of the algorithm is publically available and is not described here. For indexing purposes information of tasks and subtask may be used (all fields) and text data from emails and files related to the task. For query creation an email body may be used where all service words such as “and, or, I, me”, etc. are deleted as in step 1020. Another classification algorithm may be used in later versions of applications to best fit in terms of speed and quality and improve accuracy of classification.

In an exemplary embodiment, when new emails are received and classified to a specific task then an up-folding algorithm may be used to make re-indexing of a database. The Up-folding algorithm is also publically available and is not described here. For re-indexing a new email body may be used without service words.

If the tool 100 was not able to classify email to any of user tasks then the email is kept in special service task called “Not Sorted Data”. The user then can open list of emails in this task and sort emails manually between tasks.

New emails may be grouped by email subject in order to simplify managing emails for user as in step 1026. Certain rules may be applied to group emails. First, all subjects may be changed to small (not capital) letters. Spaces in the beginning of subject and at the end of subject may be truncated. Service prefixes such as “RE” or “FW” may be truncated. Then a similarity validating algorithm may be used to compare subjects. E.g. if subject contain all same words but different date at the end it, may be considered as a similar subject. A group may then be formed which may contain all emails with similar subjects. If the subject of email is unique then the group may consist of one element. Emails which are sent by the user may also be added to the group with the subject. The group may contain sent emails and similar emails subjects. Information on emails and groups may then be stored in an external file.

Once an email is classified as related to specific task it may then be added to a list of emails related to the task (standard collection may be used as data structure to keep this information) as in step 1030. A list of emails related to the task may then be saved in external file.

Once new emails are received and allocated to tasks then visual changes may be applied to task shapes in order to visually represent that new emails arrived as in step 1032. In addition, if some of emails are set for follow up then visual/sound notification may be made.

Automatic task creation is a tool to cooperate and communicate efficiently with colleagues. As a method it creates an open, disjoined distributed database of tasks that users may exchange between each other. The user may receive not only information on emails but also on tasks associated with it which help the user to manage his information flow and his time more effectively. For example new emails together with tasks of high priority may arrive to an employee from his manager. The employee may then fully recognize task and information related to it, including strategic objective, and task and expectations.

The tool 100 may create a visual representation of emails. Once an email is received and linked with specific tasks or kept in Not Sorted Data the user can see all emails related to a task as described below. If Option A of task representation is used—the user may click on a water drop symbol on the task box and a list of all emails may be opened in Email List form. If Option B of representation is used—the user may click on a task shape, then the task shape may moves to a left upper corner of working area of the tool 100 and transform to bubbles with animation. Inside of the large bubble water drops may be indicated representing emails. Email groups may be indicated by bigger water drops then single emails. A user may be able to open a group/email by simple clicking on group/email water drop shape. The user may also click on specific icons of large water drops to open lists of all emails related to tasks if he prefers working with list of emails.

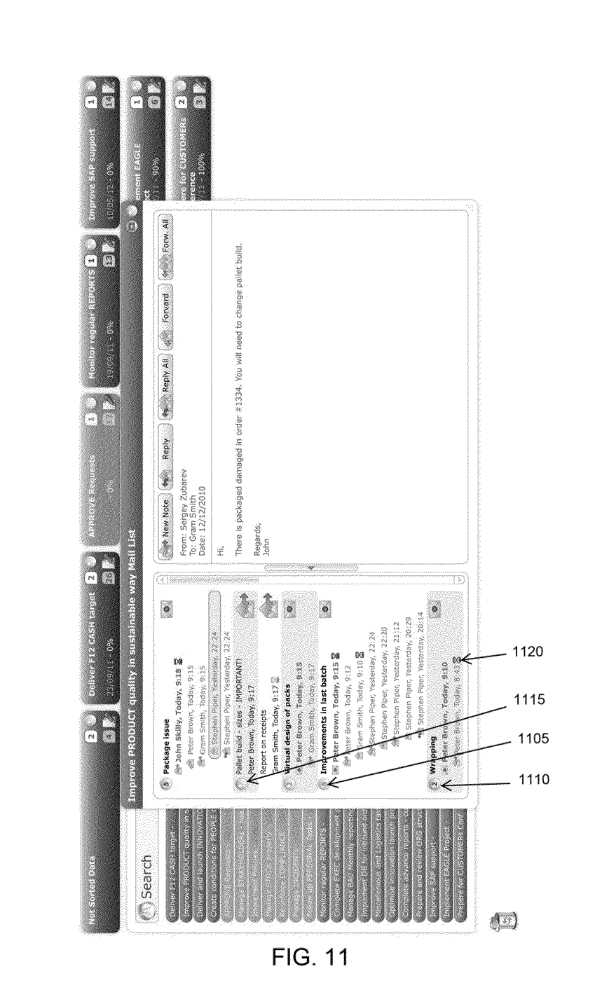

Referring to FIG. 11, in an exemplary embodiment, in an email list the user can see a list of groups of emails. A group 1105 may have a list of eight emails with the header “Improvements in last batch” A group 1110 may have a list of two emails, with the header “Wrapping”. A group 1115 may have a list of one email with no header. Every group or single email may be represented by Subject (name of group) and icons may show the state of group/email—unread/read/responded/forwarded. All emails sent by a user may also be shown in the related group. Groups/emails may be marked with a water drop of a specific color depending on priority of group/email.

In an exemplary embodiment, a water drop symbol for emails related to the group may be indicated in a list where every item is represented in the format: Name of sender, Date/Time email sent. Emails may be sorted in order from most recent emails sent/received on top of list to oldest emails in the bottom of the list. The user can hide/unhide all emails in a group by double clicking on water drop symbols of a group/email. Water drops indicating group/email may also contain numbers of emails in the group. If there only one email in a group then there is no indication of number.

In an exemplary embodiment, the user can open a group/email to see text of the particular group/email by double clicking on any email in the group list. In Option B of the representation the user also can open a group/email by simply clicking on an email shape (water drop). Then a standard email client form—window may be opened (Email form) with all texts of all emails in the group from most recent email to the oldest received/sent email.

In an exemplary embodiment, the tool 100 may sort emails by priority as displayed in 1115—red (highest) priority, then 1105—orange (medium) priority, and then 1110—green (low) priority. In order to simplify choice of reading most important and valuable emails to the user, priority of emails may be used. All emails may be sorted within the list of all emails related to a task based on priority. Priorities of email may be calculated based on two scales—Importance and Urgency of email. Both scales may be indicated on the Email form. Shape of scales may be similar to a Task—a slider with 3 steps, each step may be represented by color—green, amber, red, the slider may change its color when the user sets it to a specific position.

In an exemplary embodiment, once the user changes the Importance and/or Urgency of the email, the following formula may be used to calculate priority of the email. First, ROI of the email may be calculated: ROI=I*w1+U*w2, where I—importance of emails (values are 1-3), w1—weight of importance=5; U—urgency of email (values are 1-3), w2—weight of urgency=1. Then priority is calculated: P=1 (Low), when ROI<=12; P=2 (Medium), when 13<=ROI<=16; P=3 (High), when ROI>=17. Ranges may be set by the user and may be subject to change if required. The user also can change Importance and Urgency of an email in a quick way without opening of email form via a context menu—click on email group/email in the list to select, right click mouse to open context menu, then choose Importance or Urgency of email in the menu, then choose value from submenu.

In an exemplary embodiment, once the user changes scales of Importance and/or Urgency, ROI and Priority of email are recalculated and indicated by changing of color of water drop symbol of group/email in the Email list or email shape (if Option B is used). Water drop symbol color may correspond to—Green=Low priority email, Orange=Medium priority, Red=High priority. Emails may be resorted in the list based on ROI, where email with most high value of ROI is located on top of list and with emails with the least value on the bottom of the list.

The tool may perform automatic priority identification. When a new email is received the tool 100 may automatically assign Importance and Urgency to the email. Information on value of Importance and Urgency of email may be added as part of a semantic tag attached to the email. If another user also uses the tool 100 then a semantic tag may be read by the tool 100 when the email is received. Thus values of Importance and Urgency of email are identified and reflected by the water drop symbol, and color of group/email and sorting in list of emails is done accordingly to ROI. If there is no semantic tag attached (email sent from standard email client or web site) then the tool 100 may use a classification algorithm to query the email on key words such as “Urgent”, “Important”, etc. The tool may also consider if the email was set with an importance flag (standard functionality of modern emails format) and date to respond to identify priority of email. The tool 100 may assigns ROI and priority to the email based on results and represent the email in the list accordingly. The user can change Importance and Urgency based on his judgment when working with list of emails.

In an exemplary embodiment, the tool 100 may sort emails by Drag and Drop between tasks. When an email is received and assigned to a specific task, the user may want to change this assignment and place the email with another task. The user can do it with simple drag and drop operation as follows. The user may select a group/email in the email list by a single click on it, then press and hold left button to start dragging group/email, then carry the email to another task and drop it when he is over targeted task shape. The complete email group may then be moved, and single emails in the group may not be allowed to move to another task in order to maintain data integrity. If Option B of representation is used then the user can sort of emails by drag and drop of email shapes (water drops) from one task to another. Once a group/email is moved to a new task, the database may be re-indexed as the new group/email is now linked to different task. In particular it may be used when the user moves emails from “Not sorted data” task shape to a specific task. All new emails that are received with this subject may then be automatically assigned to the new task target.

In an exemplary embodiment, the tool 100 may delete and restore emails. The User can delete any email by: (1) selecting email in the list and press delete button of key board, or right click to open a context menu and select “Delete”, (2) drag and drop email from the list or task shape if Option B is used to the Garbage Bin. The user can restore emails by opening the Garbage Bin and: (1) select “Restore” from context menu, or (2) drag and drop the email to a specific task. When an email is deleted, re-indexing of database may not be performed.

The tool 100 may respond to emails by replying and forwarding. The user can reply to an email, reply to all or forward emails by clicking a corresponding button in an Email form. The Email form may also contain scales of Importance and Urgency of the email which can be changed.

There is also a new function—“Forward to all”. This function may be used when user wants to respond to all users in the list of recipients and keep original attachments of received email still attached to new email. When user clicks on the button “Forward to all”, a new email may be created with all initial text from a received group of emails, and a list of recipients filled in from an original group of emails and the original email attachment may be attached to it. The user then may type new email text and send it.

In an exemplary embodiment, the user can create and send new emails. The user may open an email list and click on a button “New Note” or right click on a task shape to open a context menu and select “New Note”. Then an email form may be opened. The user may not be allowed to send email from the “Nor Sorted Data” task shape. Thus, emails may be sent from a specific task in the tool 100. When new mail is sent from the tool 100, a semantic tag may be attached to the email.

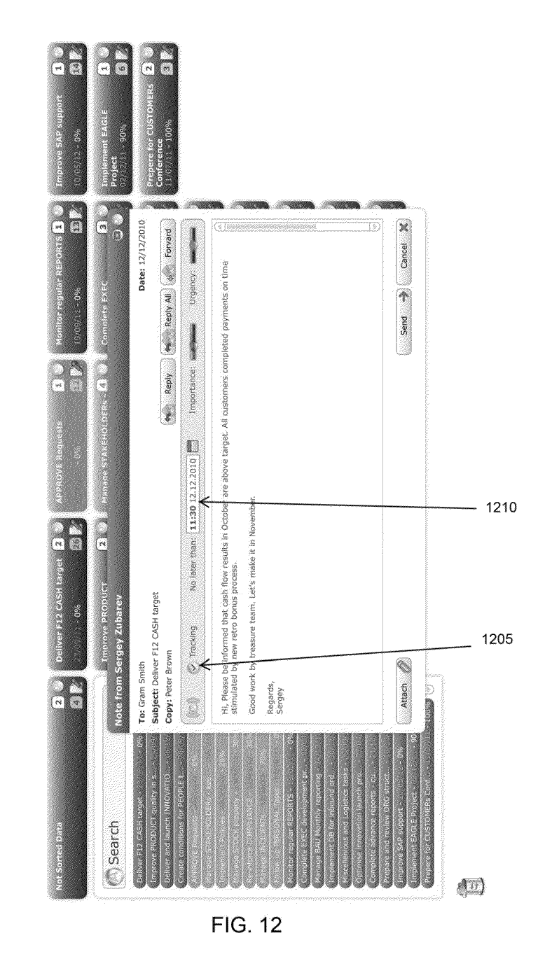

Referring to FIGS. 11-12, in an exemplary embodiment, the tool 100 may activate tracking or alert for emails. When the user expects some information, the tool 100 may help the user to track specific emails. To activate email tracking the user may do one of: (1) when sending email click “Tracking” box 1205 in the email screen, (2) select a email group 1115 (FIG. 11) from the list, right click to open a context menu, and select “Track email”. The user also can select a date/time 1210 by which he expects a response. There may be a specific icon 1120 located at the right side of the email list item indicating the following: an icon 1120 of blue color may indicate that a group or email is being tracked and a response is not received; an icon 1120 of green color may indicate that a group or email is being tracked and a new response is received; an icon 1120 of red color may indicate that a group or email is being tracked and an answer is not received, such that the answer is not received either by a time set by the user when the sent the email or five days after the sent email if the user did not set the time. The icon 1120 may help the user visually identify that responses are received as the user expected or the user needs to take an action. To see emails in tracking state the user also can sort an email list by tracking status. Tracking of a group email is kept until the user cancels it by clicking the box off in the email screen.

In an exemplary embodiment, if the user wants to be notified when response is received for email with follow up state the user may click the box “Set alert” in the email screen to activate the alert. The alert may be done by a pop up window or by sound depend on default settings.

In an exemplary embodiment, the tool 100 may activate tracking and/or alert for emails by default. If the user wants tracking status to be set every time the user sends emails with specific attributes or tracking is activated for already sent/received groups of emails, he can use settings of tracking or alerting by default. In this case every email which satisfies a set conditions may be automatically set for a tracking or alerting state. To do this the user may right click to open a context menu, select “Settings”, then select “Tracking/Alerting by default”. Tracking by default settings form may then be opened where he can choose following conditions: (1) email address, (2) priority, e.g. all emails with High priority will be tracked/alerted, (3) subject as text, (4) task—as task description. The emails that are classified as linked to that task may be in tracking/alerting state by default. He also can click boxes—“Tracking” and “Alerting” to indicate what will be applied.

In an exemplary embodiment, once the user has chosen conditions he then may press the button “Create tracking/alerting rule”, and enter the name of a rule. The rule may then be added in the list on that screen. Then the user may save settings for tracking/alerting by pressing the “Save” button, after which settings may become in effect and all emails that satisfy chosen conditions may be set to follow up/alert state. Alternatively the user can click on the “Cancel” button and the setting may not be saved and activated.

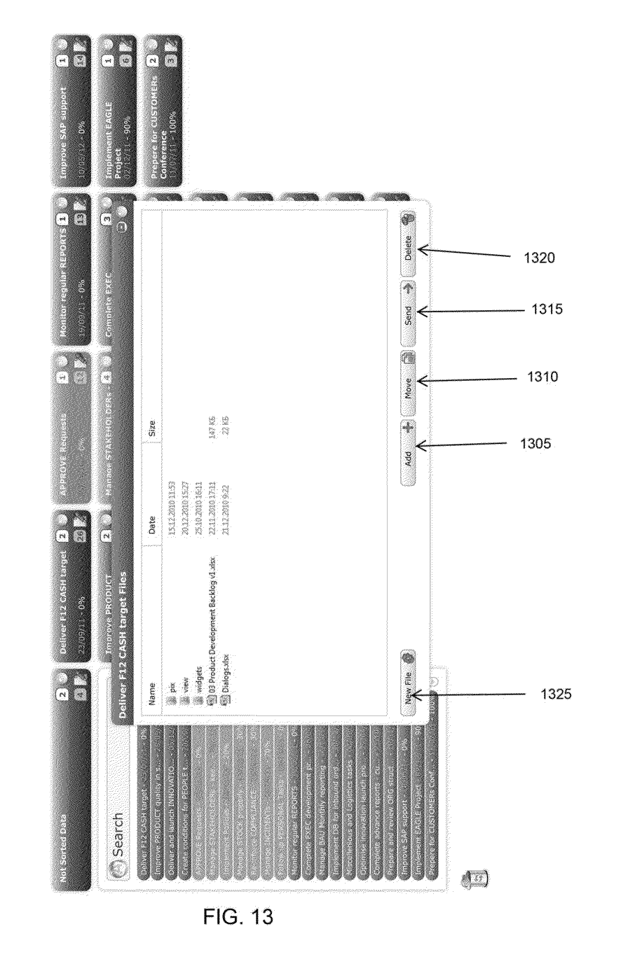

Referring to FIG. 13, in an exemplary embodiment, the tool 100 may add a new file to a task using, for example, an Add button 1305. The user may move a file to another task with, for example, a Move button 1310. The user may send a file by, for example, email, with a Send button 1315. The user may delete a file from the task by pressing, for example, the Delete button 1320. The user may create a new file for the task with, for example, the New File button. 1325. The following describes workflow of working with the files. The files may now be organized in the way that they are linked and stored with a specific task. This may help the user to find quickly required files that are part of information related to a specific task the user works with. This feature may also reduce the time the user spends on creating folders for file storage. The same files can now be allocated and linked with different tasks. This may help the user to allocate files where the user needs them to get quick access to information when the user works with specific tasks. The user can create new files or add existing files to the task. There may be a specific file folder created when the task is first created by user. The file folder may keep all user files related to a specific task. The file folder may be located in a default root file directory.

In an exemplary embodiment, referring to FIG. 13, to create or add a file to a task the user may left click on the File Icon located on the task shape. Then the File List form may be opened (FIG. 13) which may present a list of all files of all types linked with the task. Then the user may right click when the mouse cursor is inside of the File List form to open a context menu, and choose one of functions: (1) “Create new file” in order to create and add a new file to the task, (2) “Add file” in order to add and link an existing file to the task, or (3) “Move file” in order to add a link to the task and move a physical file to the Task directory.

In an exemplary embodiment, if the user creates a new file then he will need to select one of known types of files in the operating system in the opened list. After that native application is opened with a default file name. However, the file may have been already saved in task file folder with the default name and added to task File List. If the user chooses “Save as” function later on after working with native file application, the user may be navigated to the default file folder of task where the user can save file with new name.

If the user adds an existing file then the File Selection form may be opened in order to find a file the user wants to add. The user can navigate through his file directories to find a required file and then may press “Add file”. A Physical file may not be added to file folder of the task to maintain data integrity. Instead, a link (or shortcut) may be created in the file folder. In the File List form the file may be indicated with a file type icon as if it were physical file. The user can then open this file by double clicking on the file icon in the list in File form. If the user moves an existing file then the same operation to create a link with the Task as in the Add file function may be performed and the file may physically move from an existing directory to a Task directory.

The tool 100 may download files from email attachments. The user may receive many emails with file attachments. In order to keep information in these files in an organized way, a feature of downloading of files to task file list is introduced. The user may download all files from emails related to the task by: right clicking to open a context menu when the mouse cursor is over a task shape, or in a File List form, choosing “Download all files from email attachments”. Then all emails contained in Email List may be checked by the tool 100 to determine if they have the attached files. If a file attachment is found then the tool 100 may check to avoid write over of an existing file or file duplication by checking If a file with the same name is located in a task file list and/or also is located in any other tasks file lists. If the same file name is not found then the file is saved in a task file folder.

In an exemplary embodiment, if the same file name is found in different tasks then the tool 100 checks if two files are equal by checking a file control sum. If they are equal then a link to an existing file is saved to the task. If files are not equal then the user is asked for confirmation to save the file with a new name or create a link to an existing file or to not save the file. If the file is saved in a physical folder of a task then an email attachment is removed from original email and service text is added to email with full file name, file type, task name and full path to the file folder where the file was saved. This may help to reduce Inbox space use. The user may not be allowed to download files for the service task “Not Sorted Data”.

The tool 100 may add and move files between tasks by Drag and Drop. The user can add or move files between tasks by a simple drag and drop operation. If the user wants to move a file from one task to another, then the user may first open a File List of the task (source). The user may select a file by left clicking on file icon, then press a left button of the mouse to start dragging it. The user can drop the file when he is over another task shape (target). The file may then be removed from a source task and added to a task target. Animation of the file move may be played to visually indicate file move. The physical file may be moved from a file folder of the task source to the one of the task target.

In an exemplary embodiment, If the user wants to add an existing file which is located in task (source) to another one (target), he may press the CTRL button before the user starts dragging the file. The file may then be added to a target task by creation of a link. Animation of the file may be added to visually indicate action. The physical file may not be moved anywhere.

The tool 100 may delete and restore files. The user may need to delete a file from the task thus deleting a link of file to the task and/or physical file. The user may be able to restore links and physical files by a restore operation. To delete a file from a task the user may open a File List form, select a file by a single left click and then press the delete button on a keyboard or right click to open a context menu and select the “Delete file” function. The tool 100 may then check if the file is linked only with the task (source) and no other tasks has a link to this file. If this is the case then the user is prompted for confirmation of moving the physical file to the Garbage Bin of the operating system. If the user confirms moving the physical file to the Garbage Bin, then the file is deleted from file folder of task and located in the Garbage Bin of the operating system. The file name and text “was linked to Task X” may be located in the Garbage Bin. Animation may be played at the file deletion and moving of the file link to the Garbage bin. If the file is still linked with another task then the link in the task source is removed, and the file link for the task source is moved to the Garbage Bin with animation play.

In an exemplary embodiment, the user can restore a link to a file by opening the Garbage Bin, and select a file name from the list, right click to open context menu, and choose “Restore file”. A file link may then be restored in the task. The physical file may be moved from the Garbage Bin of the operating system to a task file folder. If the file was physically deleted from the Garbage Bin of the operating system then notification may be given to user on inability to restore file. If the user accidently deleted the physical file from the task file folder then when the user tries to open file from Task File list the tool 100 may not be able to open the deleted file. In this case the tool 100 may open a file search form with a suggestion to the user to find physical file. If the physical file is found then it may be physically moved to the task file folder, a link is created with the task and a file link will be shown in the File List form.

The tool 100 may search for tasks, emails and files. The user may need to find specific information such as a task, subtask, email or file. There may be a Search form constantly located at the left side of the working area of the tool 100. The search form may consist of a search field to enter text for search and a list of all tasks indicated in the form by default. Tasks may be indicated by items containing task name, date due, % of task completed, and number of unread emails in the task. Tasks items in the list may be sorted by Priority and then by weight within priority. Every task item in the list may be indicated by specific color of task priority—same as colors of priorities as described in Item 2. The user can left click to any of task in the list and then the Task Form may be opened for that task. This may help the user quickly find the task he needs to work with. The user can type any symbol in a search field of a Search form and generate a list of items that may contain typed text in the Search form, it may be Task/Subtask name, group/email subject, or File name. A Default task list may not then be visible but only the found items may be visible. The user can click on any found item and the tool 100 may open an item accordingly in specific form—Task/SubTask form, Email form, or File List form. This may help the user quickly find information the user needs.

It should be understood, of course, that the foregoing relates to exemplary embodiments of the invention and that modifications may be made without departing from the spirit and scope of the invention as set forth in the following claims.

What is claimed is:

1. A system for managing user task information comprising:
a. The possibility to enter, edit, and delete user task information, which may include such data as: strategic objective, task, expectations/objectives as success criteria, accountable, date of targeted completion, set of subtasks
b. Adding email messages and files to a task by linking them with a task, retrieving of emails messages and files for a task by user request, and or deleting them from a task
c. Automatic classification of a new received email messages by tasks

2. A system for managing user task information of claim 1, comprising a method of measuring a task priority based on the rate of importance which includes:
a. Using five key parameters: importance, urgency, difficulty, risk of delay and completion
b. Using visual representation of scales with distinct colors and colored water drops with changing color for clear visual identification of the state of a scale
c. Formula of the calculation of priority, including the identification of the priority of tasks based on range

3. The system for managing user task information of claim 1, comprising a method of weighting of tasks based on specified parameters which includes:
a. Using of four parameters such as: risk of delay, percent of task completion, difficulty of the task, number of unread emails messages linked with the task in the unread state
b. Formula of the calculation of the task weight

4. The system for managing user task information of claim 1, comprising a method of representation of tasks by priority with shape, size, and color, including:
a. Depiction of tasks by a colored box located in four columns and by rows, where each task has specific position and color in a column and row based on measured priority and weight, and where colors were used, such as red, yellow, green, and blue
b. Alternative depiction of tasks by a colored shape such as a bubble displayed in columns, where each task has specific position and color based on measured priority and weight, as well as the size of the shape, which depends on the weight of a task

5. The system for managing user task information of claim 1, comprising a method of changing the representation of a task after changing of information, such as receiving a new email messages, or reading email messages by the user, which includes:
a. Triggering the re-measuring of the weight of a task
b. Visually changing the position of a task on a display within the column that is located and its size based on new weight of the task

6. The system for managing user task information of claim 1, comprising a method of email messages classification based on semantic emails tagging that includes:
a. Inclusion of a semantic tag into email, which may include data such as: name of a task, task priority, and other required information
b. Using a semantic tag of the email message in order to link an email message to a specific task

7. The system for managing user task information of claim 1, comprising a method of automatic task creation for a user based on semantic tag information included in an received email message

8. The system for managing user task information of claim 1, comprising a method of measuring of email messages that are priority based on the importance of the emails and urgency

9. The system for managing user task information of claim 1, comprising a method of representation of email message groups by water drops with different shapes, sizes and colors, such as red, yellow, green, and blue. The size of a group and the color depend on the measured priority of the email group and the number of emails in the group

10. The system for managing user task information of claim 1, comprising a method of email tracking by response, which includes:
a. Setting of a specific email for the tracking state
b. Tracking the received responses for an email message
c. Indicating the email message with a specific icon or sign representing that an email message is being tracked, or a response received, or a response is not received by a specific time

11. The system for managing user task information of claim 1, comprising a method of unused information archiving such as tasks, subtasks, emails and files which includes:
a. Recording of when the information was last used
b. Regular checking for exceeding the specified time limit during which data was not used
c. Hiding of information such as tasks, subtasks, emails and files which exceeded a specified time limit
d. Unhiding of information, such as tasks, subtasks, emails, and files upon the user's request.
